(19) United States
(12) Patent Application Publication
(10) Pub. No.: US 2015/0377686 A1
(43) Pub. Date: Dec. 31, 2015

(54) FUEL TANK HAVING AN ACTIVATED CARBON FILTER AND METHOD TO DISPLAY THE FUEL LEVEL OF THE FUEL TANK WITH SIGNAL SUPRESSION AT A CRITICAL NEGATIVE PRESSURE DURING REGENERATION OF THE ACTIVATED CARBON FILTER

(71) Applicant: AUDI AG, 85045 INGOLSTADT (DE)

(72) Inventor: HARALD HAGEN, CREUSSEN (DE)

(73) Assignee: AUDI AG, 85045 INGOLSTADT (DE)

(21) Appl. No.: 14/751,434

(22) Filed: Jun. 26, 2015

(30) Foreign Application Priority Data
Jun. 27, 2014 (DE) 102014009634.3

(51) Int. Cl. G01F 23/36; B60K 15/03

(52) U.S. Cl. CPC G01F 23/36; B60K 15/03; B60K 2015/03217

(57) ABSTRACT

A fuel tank for a combustion engine includes measuring and signal generating devices constructed to measure a filling level or filling volume within the fuel tank, and to transmit a first signal corresponding to the filling level or filling volume to a fuel indicator; a signal modifying device constructed to modify the first signal when the fuel tank undergoes a deformation; and an activator activating the signal modifying device when a valve between an activated carbon filter communicating with the fuel tank and an intake tract of the combustion engine assumes an open position.

### CROSS-REFERENCES TO RELATED APPLICATIONS

This application claims the priority of German Patent Application, Serial No. 10 2014 009 634.3, filed Jun. 27, 2014, pursuant to 35 U.S.C. 119(a)-(d), the disclosure of which is incorporated herein by reference.

### BACKGROUND OF THE INVENTION

The present invention relates to a fuel tank for a combustion engine, including measuring and signal generating devices constructed to measure a filling level or filling volume within the fuel tank, and to transmit a first signal corresponding to the filling level or filling volume to a fuel indicator; a signal modifying device constructed to modify the first signal when the fuel tank undergoes a deformation; and an activator activating the signal modifying device when a valve between an activated carbon filter communicating with the fuel tank and an intake tract of the combustion engine assumes an open position.

The following discussion of related art is provided to assist the reader in understanding the advantages of the invention, and is not to be construed as an admission that this related art is prior art to this invention.

In motor vehicles fuel tanks with devices to measure the filling level or filling volume of the fuel tank, to generate a signal correlating with the filling level or filling volume of the fuel tank and to transmit the signal to a fuel indicator on an instrument panel of the motor vehicle are generally known.

Fuel tanks of modern motor vehicles are furthermore equipped with tank venting systems. On the one hand, these systems prevent that a negative pressure is established within the fuel tank in case of a greater increase of ambient temperatures due to the evaporation of fuel associated therewith, and on the other hand allow escape of the gas mixture displaced by the fuel from the gas compartment or headspace of the fuel tank during refueling.

The tank venting system usually includes a carbon filter, which is connected to the gas compartment or headspace via a tank venting line. During refueling of the fuel tank, the gas mixture displaced by the fuel is supplied from the gas compartment or headspace into the activated carbon filter in order to prevent an undesirable escape of hydrocarbons into the environment.

In order to remove the volatile hydrocarbons again from the activated carbon filter, the activated carbon filter has to be regenerated periodically. For this purpose ambient air is usually suctioned through the activated carbon filter into an intake tract when pre-determined load conditions of the combustion engine are present, which may include driving- and stationary phases, in order to rinse the activated carbon filter from hydrocarbons and to combust the entrained hydrocarbons in the combustion chambers of the combustion engine.

For this purpose, the activated carbon filter is on one hand connected to an intake tract of the combustion engine via a suction line, and on the hand to the environment via an in- and outlet. The suction line includes a valve, which is described in the art as purge valve or venting valve and whose opened and closed position is controlled by an engine controller unit of the combustion engine.

A fuel tank including an activated carbon filter and a suction line with a purge valve leading from the filter to the intake tract of the combustion engine is for example disclosed in US 2007/0113633A1 or US 2009/0277251.

During refueling of the fuel tank, the purge valve is closed, so that the gas mixture displaced from the fuel tank by the fuel can escape into the environment through the inlet and outlet after filtration by the activated carbon filter. During regeneration of the activated carbon filter, the purge valve is opened, so that the negative pressure within the intake tract acts on the activated carbon filter and ambient air flows through the in- and outlet into the activated carbon filter, and through the activated carbon filter into the intake tract. When the fuel tank is a pressure tank, the in- and outlet of the activated carbon filter may be provided with a stop valve, which is normally closed and is opened during refueling and regeneration of the activated carbon filter.

Because the activated carbon filter communicates with the gas compartment or headspace of the fuel tank through the tank venting line, a negative pressure is also established within the gas compartment or headspace of the fuel tank during regeneration of the activated carbon filter, which may result in deformation of the fuel tank. Such a deformation can lead to a distortion of the filling level or filling volume signal transmitted to the fuel indicator, so that a filling level or filling volume is displayed that deviates from the actual filling level or filling volume.

In order to prevent this, DE 10 2010 045 212 A1 already discloses a fuel tank and a method of the aforementioned type. In this known method, the deformation of the fuel tank is detected and a correction value for the signal transmitted to the fuel indicator is calculated on the basis of the detected deformation. This solution, however, requires an active detection of the deformation of the fuel tank, and thus involves a significant effort.

It would therefore be desirable and advantageous to provide an improved to obviate prior art shortcomings and to invention to provide an improves fuel tank and a method of the aforementioned type so that the required effort can be reduced.

### SUMMARY OF THE INVENTION

According to one aspect of the present invention, a fuel tank for a combustion engine includes measuring and signal generating devices constructed to measure a filling level or filling volume within the fuel tank, and to transmit a first signal corresponding to the filling level or filling volume to a fuel indicator; a signal modifying device constructed to modify the first signal when the fuel tank undergoes a deformation; and an activator activating the signal modifying device when a valve between an activated carbon filter communicating with the fuel tank and an intake tract of the combustion engine assumes an open position.

According to another aspect of the present invention a method for displaying a filling level or filling volume of a fuel tank of a combustion engine, includes determining the filling level or filling volume; generating a signal corresponding to the filling level or filling volume; transmitting the signal to a fuel indicator, and modifying the signal when the fuel tank undergoes a deformation, wherein the modifying of the signal is performed when regenerating an activated carbon filter communicating with the fuel tank.

In other words, the modification of the signal is not initiated when a deformation of the fuel tank is determined, as in the method known from DE 10 20110 045 212 A1, but is rather generally initiated during phases of regeneration of the activated carbon filter, in which the purge valve between the activated carbon filter and the intake tract is in an opened position.

The invention is based on the idea that at least in fuel tanks that communicate with the environment via a tank venting line and the activated carbon filter, a negative pressure within the fuel tank that leads to deformation of the fuel tank and with this to a distortion of the signal, can only be established when the fuel tank communicates with the intake tract of the combustion engine during regeneration of the activated carbon filter. This is always the case whenever the purge valve between the activated carbon filter and the intake tract is open.

While it is generally possible to modify the signal during the entire duration of regeneration of the activated carbon filter or during the whole period in which the purge valve opened position is in the open position of, an advantageous embodiment of the invention provides that the signal is only modified when a negative pressure within the fuel tank falls below a critical negative pressure-threshold. For this purpose, the negative pressure within the fuel tank is advantageously determined and is compared to the critical negative pressure-threshold.

Fort this purpose, the vapor pressure within the fuel tank is advantageously measured by means of a first pressure sensor and the ambient pressure by means of a second pressure sensor. To determine the negative pressure within the fuel tank, the pressure difference is calculated from both measured values. On the basis of this pressure difference, the deformation of the fuel tank can be deduced.

As soon as the negative pressure within the fuel tank no longer falls below the negative pressure threshold, a modification of the signal is no longer necessary, so that the un-modified signal is transmitted to the fuel indicator again.

According to the invention, the modification of the signal can be achieved in two different ways. According to a first alternative of the invention, the potentially incorrect signal is suppressed or faded out. In this case, a substitute signal, which correlates with a filling level or filling volume that was determined immediately prior to the initiation of regeneration, is advantageously transmitted to the fuel indicator in place of the suppressed or faded-out signal. In the case of an electronic fuel indicator it can alternatively be provided to continue displaying the filling level or filling volume displayed up to that point during the suppression or fade-out of the signal.

A second alternative of the invention on the other hand provides that the potentially incorrect signal is corrected by a correction value, which is advantageously calculated on the basis of the negative pressure within the fuel tank and is used to correct the signal, before the signal is provided to the fuel indicator as corrected signal.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic view of a fuel tank of a combustion engine according to the invention, including an activated carbon filter and a purge valve between the activated carbon filter and an intake tract of the combustion engine;

FIG. 2 shows characteristic curves of the filling level and filling volume, which show a relationship between the filling volume and a measured filling level within the fuel tank;

FIG. 3 shows a schematic flowchart of steps of a first alternative method according to the invention, in which a potentially incorrect signal is faded out or suppressed and is replaced by another signal;

FIG. 4 shows a schematic flowchart of a second alternative method according to the invention, in which a potentially incorrect signal is corrected;

FIG. 5 shows a schematic view of components of a controller for implementing the first and second alternative methods.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

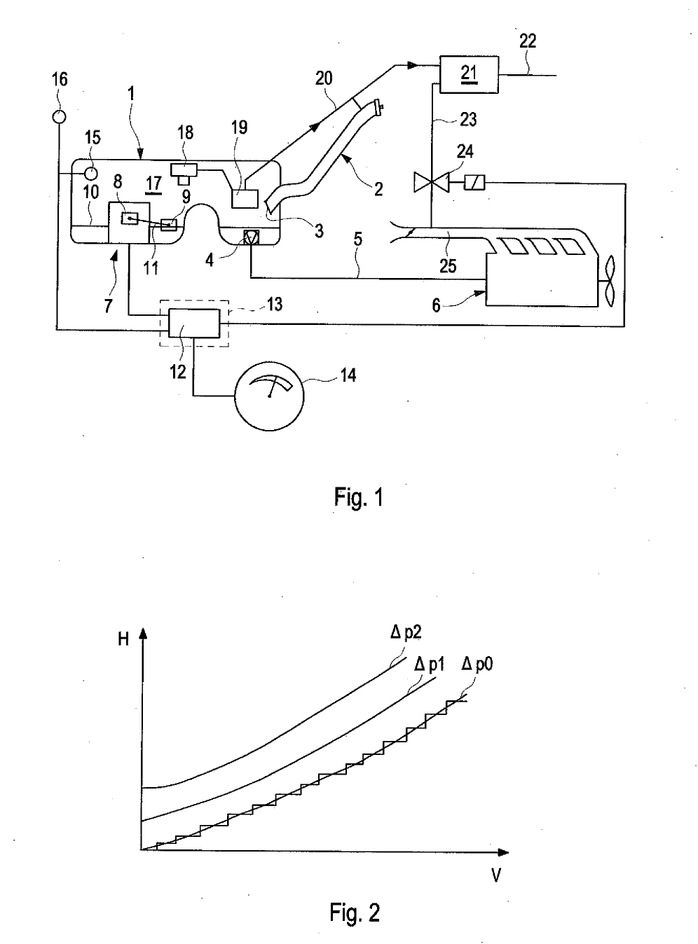

Turning now to the drawing, and in particular to FIG. 1, there is shown a schematic representation of a fuel tank 1 of a motor vehicle. The fuel tank 1 has a closable filler tube 2 for refueling, which is provided with a flap 3 at the bottom. Fuel is withdrawn from the tank 1 by a fuel pump 4, which transports the fuel through a fuel line 5 to a combustion engine 6 of the motor vehicle.

A measurement- and signal generating device 7 is situated within the fuel tank 1, which measures the actual filling level of the fuel within the fuel tank 1 and generates a filling level signal that correlates with this filling level.

The measurement- and signal generating device 7 therefore comprises a filling level signal generator 8 and a float 9, which floats at the fuel surface 10 and is coupled to the signal generator 8 via an arm 11. When the filling level within the fuel tank 1 changes, the angular orientation of the arm relative to the signal generator 8 changes. This change causes a change of an electrical resistance within the signal generator 8, which correlates with the filling level of the fuel within the fuel tank 1.

The filling level signal generated by the filling level signal generator 8 is provided to a controller 12, which can be integrated into an engine controller unit 13 of the combustion engine 6, and a corresponding filling volume is calculated in the controller 12 on the basis of characteristic curves. The controller 12 generates a volume signal, which correlates with the calculated filling volume and is provided by the controller 12 to a fuel indicator 14 on an instrument panel of the motor vehicle.

As described in the above mentioned DE 10 2010 045 212 A1, on the one hand, deformation of the fuel tank 1 may result in distortion filling level. On the other hand, the relationship between the measured filling level and the calculated filling level of the fuel tank 1 depends on a potential deformation of the fuel tank 1. The deformation of the fuel tank 1 in turn depends on the pressure difference Δp between the atmospheric pressure pA and the vapor pressure pK within the fuel tank 1.

To further illustrate this dependence, FIG. 2 shows three filling level-filling volume-characteristic curves, which show the correlation between the filling volume V and the measured filling level H for three different pressure differences Δp0, Δp1 and Δp2 within the fuel tank 1, with p0=0 mbar, p1=−20 mbar and p2=−40 mbar. As shown in FIG. 2 only for the lowest curve, in reality the characteristic curves do not have a steady course, but have a stepped course.

To measure the vapor pressure pK within the fuel tank 1. or the atmospheric pressure pA, two pressure sensors 15, 16 are used, wherein pressure sensor 15 is arranged within a gas compartment or headspace 17 of a fuel tank 1 and pressure sensor 16 is arranged outside of the fuel tank 1. The measured values of both pressure sensors 15, 16 are provided to the controller 12.

The fuel tank 1 is provided with a tank venting system, which enables venting of the fuel tank 1 during refueling of the motor vehicle as well as during increase of the ambient temperature. The tank venting system includes one or more venting valves 18 (only one is shown), situated within the gas compartment or headspace 17, which are connected to an activated carbon filter 21 outside of the fuel tank by a liquid trap 19 and a tank venting line 20.

The activated carbon filter 21 prevents the leakage of volatile hydrocarbons (HC) from the gas compartment or headspace 17 into the environment during venting of the fuel tank 1 and therefore contains activated carbon, which absorbs the volatile hydrocarbons (HC). The activated carbon filter 21 has an in- and outlet 22 communicating with the environment. In order to regenerate the activated carbon filter, it is connected by a purge line 23 to an intake tract 25 of the combustion engine 6. The purge line contains an electromagnetic purge valve 24, which is normally closed and is opened by the controller 12 at the beginning of each regeneration process of the activated carbon filter 21. When the purge valve 24 is in the opened position, ambient air is suctioned into the activated carbon filter 21 due to the negative pressure within the intake tract 25, and through the activated carbon filter into the intake tract 25. Thereby, the activated carbon filter 21 is rinsed and the volatile hydrocarbons are combusted within the combustion chambers of the combustion engine 6. After completion of the regeneration, the purge valve 24 closes again.

When, at opened purge valve 24, the negative pressure within the intake tract 25 acts on the activated carbon filter 21, this negative pressure is relayed through the tank venting line into the gas compartment or headspace 17 of the fuel tank 1. Even though the fuel tank 1 is resistant against deformation to a certain degree, a deformation of the fuel tank 1 may result if the negative pressure pU within the fuel tank 1 falls below a pre-determined critical negative pressure-threshold pUkrit, i.e., if the pressure difference Δp between the atmospheric pressure pA and the vapor pressure pK within the fuel tank 1 exceeds a pre-determined threshold.

In order to prevent a fuel indicator 14 from displaying an incorrect filling volume resulting from such a deformation, either the filling level signal, generated by the filling level signal generator 8 or the volume signal calculated therefrom by the controller 12 is modified within the controller 12, wherein in the following two different alternative methods for the modification of signal are described.

Both alternative methods have in common that the controller 12 modifies the potentially incorrect filling level- or volume signal whenever during regeneration of the activated carbon filter 21, i.e., when the purge valve 24 is in the opened position, the negative pressure pU within the fuel tank 1 falls below the pre-determined critical negative pressure threshold pUkrit.

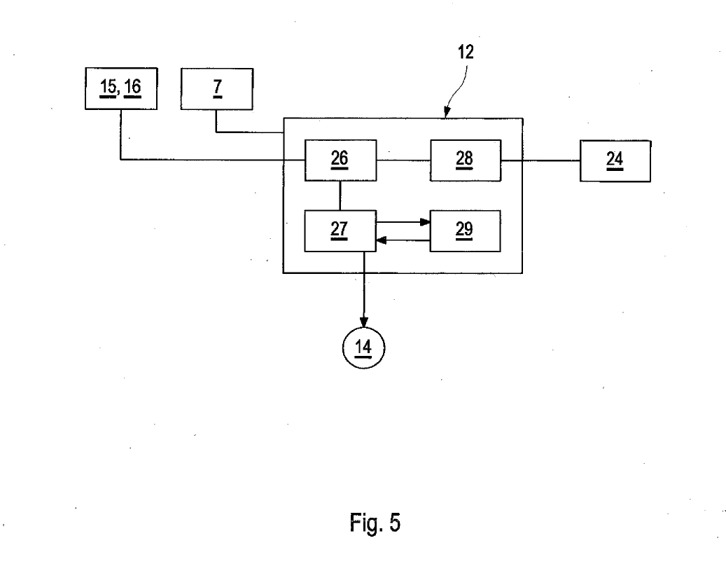

Both alternative methods also have in common that the controller 12 determines the negative pressure pU in the fuel tank 1 from the pressure difference Δp between the atmospheric pressure pA measured by the pressure sensor 16 and the pressure pK in the fuel tank 1 measured by the pressure sensor 15, and then compares the determined pressure difference Δp with the critical negative pressure threshold value pUkrit, in order to determine whether the threshold value has been undershot. For this purpose the controller 12 has three circuits 26, 27 and 28 and a memory 29 as shown in FIG. 5.

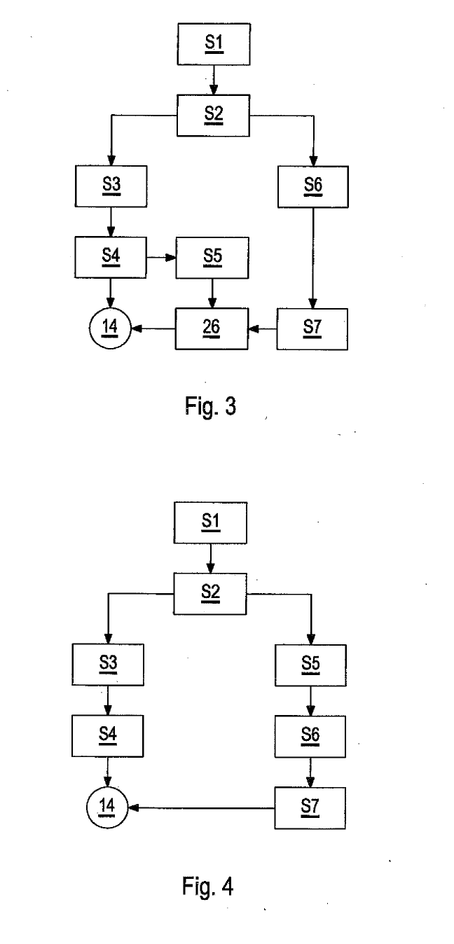

In the alternative method according to FIG. 3 the potentially incorrect volume signal is faded out or suppressed in the controller 12 by the circuit 27 and replaced by a different volume signal, which within the context of this patent application is also referred to as substitute signal.

For this purpose, as shown in FIG. 3, the circuit 28 checks in a step S1 whether the purge valve 24 is open. As soon as this is the case the circuit 26 checks whether Δp<pUkrit or Δp>pUkrit.

When Δp<pUkrit the circuit 27 determines in a step S3 the filling volume from the filling level determined by means of the filling level signal generator 8 and, without a prior modification, provides the fuel indicator in a step S4 with a filling level signal, which corresponds to the filling volume. In addition in a step S5 the filling volume is stored in the memory 29, which is connected with the circuit 27, wherein the actual filling volume respectively replaces the filling volume previously stored in the memory 29.

When Δp>pUkrit, the circuit 27 suppresses in a step S6 the potentially incorrect volume signal and in a step S7 provides a volume signal to the fuel indicator 14, which corresponds to the filling volume stored in the memory 29.

In the alternative method according to FIG. 4 the potentially incorrect filling volume on the other hand is corrected by the controller 12 and a corrected volume signal is provided to the fuel indicator 14.

As shown in FIG. 4, the circuit 28 also determines in a step S1, whether the purge valve 24 is open. As soon as this is the case, it is examined by the circuit 26 checks in a step S2, whether Δp<pUkrit or whether Δp>pUkrit

When Δp<pUkrit, the circuit 27 in a step 3 calculates the filling volume from the filling level determined by the filling level signal generator 8 and in a step S4 provides a filling volume signal corresponding to the filling level to the fuel indicator 14 without a prior modification or correction.

When Δp>pUkrit, the circuit 27 determines in a step S5 a correction value depending on the respective negative pressure pU within the fuel tank 1, which compensates the deviation of the filling volume caused by the deformation of the fuel tank 1. The factory-calculated correction values are, for instance, stored in memory 29. In a step S6 circuit 27 then corrects the calculated filling volume with the determined correction value and in a step S7 provides a volume signal to the fuel indicator 14, which corresponds to the corrected filling volume.

In both alternative methods provision of a modified filling volume signal to the fuel indicator 14 ceases as soon as either the circuit 26 determines that the negative pressure within the fuel tank 1 no longer falls below the critical negative pressure-threshold pUkrit or as soon as the circuit 28 detects that the purge valve 24 is closed.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A fuel tank for a combustion engine, comprising:
measuring and signal generating devices constructed to measure a filling level or filling volume within the fuel tank, and to transmit a first signal corresponding to the filling level or filling volume to a fuel indicator; a
signal modifying device constructed to modify the first signal when the fuel tank undergoes a deformation; and
an activator activating the signal modifying device when a valve between an activated carbon filter communicating with the fuel tank and an intake tract of the combustion engine assumes an open position.

2. The fuel tank of claim 1, wherein the signal modifying device suppresses or corrects the first signal, when in the open position of the valve a negative pressure within the fuel tank falls below a critical negative pressure-threshold.

3. The fuel tank of claim 2, wherein the measuring and signal generating devices transmit the first signal again to the fuel indicator as soon as the negative pressure within the fuel tank does no longer fall under the critical negative pressure-threshold.

4. The fuel tank of claim 2, further comprising two pressure sensors constructed to measure an atmospheric pressure and a vapor pressure within the fuel tank, said negative pressure within the fuel tank being a function of the atmospheric pressure and the vapor pressure.

5. The fuel tank of claim 1, wherein the signal modifying device suppresses the signal and during suppression of the signal, transmits a substitute signal to the fuel indicator, said substitute signal corresponding to a filling level or filling volume of the fuel tank determined and saved immediately prior to a time point at which the valve assumes the opened position.

6. The fuel tank of claim 1, wherein the signal modifying device corrects the first signal when the fuel tank undergoes the deformation and transmits a second corrected signal to the fuel indicator, said second corrected signal corresponding to a filling level or filling volume of the fuel tank in the presence of the deformation of the fuel tank.

7. A method for displaying a filling level or filling volume of a fuel tank of a combustion engine, comprising:
determining the filling level or filling volume;
generating a signal corresponding to the filling level or filling volume;
transmitting the signal to a fuel indicator, and
modifying the signal when the fuel tank undergoes a deformation, wherein the modifying of the signal is performed when regenerating an activated carbon filter communicating with the fuel tank.

8. The method of claim 7, further comprising modifying the signal when regenerating the activated carbon filter, when a negative pressure within the fuel tank falls below a critical negative pressure-threshold.

9. The method of claim 7, further comprising suppressing or fading out the signal and transmitting a substitute signal to the fuel indicator, said substitute signal corresponding to a filling level or filling volume determined and saved immediately prior to regeneration of the activated carbon filter.

10. The method of claim 7, wherein the modified signal is a corrected signal which corresponds to a filling level or filling volume of the fuel tank in the presence of the deformation.
